(19) United States
(12) Patent Application Publication
(10) Pub. No.: US 2012/0063283 A1
(43) Pub. Date: Mar. 15, 2012

(54) OPTICAL DISC DRIVE AND CONTROL METHOD THEREOF

(75) Inventor: Chi-Hung Chen, Hsinchu (TW)

(73) Assignee: LITE-ON IT CORPORATION, Taipei (TW)

(21) Appl. No.: 13/207,713

(22) Filed: Aug. 11, 2011

(30) Foreign Application Priority Data
Sep. 10, 2010 (CN) 201010284013.8

(51) Int. Cl. G11B 27/36

(52) U.S. Cl. 369/53.37; G9B/27.052

(57) ABSTRACT

A control method of an optical disc drive includes steps of: detecting data transmission is being performed between the computer system and the optical disc drive or not; stopping supplying an operating voltage to the optical disc drive if data transmission not being performed; determining whether or not an eject switch is being pressed according to a variation in potential on a shared line when a first logic level is detected, and supplying the operating voltage to the optical disc drive if a press on the eject switch is detected and after a predetermined time ejecting a tray from the optical disc drive; and determining whether or not the tray is loaded into the optical disc drive according to a variation in potential on the shared line when a second logic level is detected, and supplying the operating voltage to the optical disc drive if the tray is loaded.

This application claims the benefit of People's Republic of China application Serial No. 201010284013.8, filed on Sep. 10, 2010, the subject matter of which is incorporated herein by reference.

### FIELD OF THE INVENTION

The present invention relates to an optical disc drive adapted to be used with a computer system, and more particularly to an optical disc drive and associated control method that consumes lower power while the optical disc drive is operated at a stand-by state.

### BACKGROUND OF THE INVENTION

It is well known that most of existing computer systems is generally equipped with an optical disc drive for reading/writing data from/to an optical disc. However, because the optical disc drive is directly electrically coupled to the computer system, thereby the optical disc drive is always supplied with an operating voltage from the computer system as long as the computer system is operated at a power-on state. In other words, even there is no data transmission being performed between the optical disc drive and the computer system, the operating voltage is still supplied to an internal control circuit of the optical disc drive from the power-on-state computer system, so that the optical disc drive still consumes electric power and thus results in power waste.

To reduce the power waste, a variation of means are developed such as stopping supplying the operating voltage to the optical disc drive while no data transmission is being performed between the optical disc drive and the computer system. Without supplied with the operating voltage, the optical disc drive is fully stopped so that there will be no any electric power consumption while no data transmission is being performed between the optical disc drive and the computer system.

Please refer to FIG. 1, which illustrates a schematic block diagram of an optical disc drive adapted to be used with a computer system disclosed in an US patent US2009/0199222. The computer system includes a south bridge 17, a DC/DC converter 29, and an embedded controller (EC) 25 and an optical disc drive 100. The optical disc drive 100 includes a signal terminal 122, a power supply terminal 121, a power supply circuit 123, a controller 125, a read/write circuit 115, a spindle motor 117, an ejection mechanism 119 and an eject switch 133. In addition, the optical disc drive 100 is a slim-type optical disc drive and the computer system is a notebook computer system.

Specifically, the south bridge 17 is electrically coupled to the signal terminal 122 and is configured to output a control command to the controller 125 for controlling the controller 125 to perform a data reading or data writing operations on an optical disc 111. The DC/DC converter 29 is configured to produce and supply the operating voltage sequentially through a switch transistor 153 and the power supply terminal 121 to the power supply circuit 123. The embedded controller 25 is configured to output a transistor controlling signal to the switch transistor 153 for controlling the switch transistor 153 to be operated either at an open state or a close state. In addition, a shared line is arranged between the embedded controller 25 and the optical disc drive 100. Potential on the shared line can be pulled up to a predetermined voltage by the DC/DC converter 29 through a resistor 151, no matter the optical disc drive 100 is supplied with the operating voltage or not.

It is noted that once the power supply circuit 123 of the optical disc drive 100 is supplied with the operating voltage, accordingly the controller 125, the ejection mechanism 119, the spindle motor 117 and the read/write circuit 115 are powered, so that the optical disc drive 100 is at a normal function state which indicates that the optical disc drive 100 can work properly.

In the optical disc drive 100 as depicted in FIG. 1, the eject switch 133 has its first terminal which is electrically coupled to ground and its second terminal which is electrically coupled to the shared line through a resistor 131. The controller 125 has its ejection detecting terminal which is electrically coupled to the power supply circuit 123 through a pull up resistor 127. A diode 129 has its anode terminal which is electrically coupled to the ejection detecting terminal of the controller 125 and its cathode terminal which is electrically coupled to the second terminal of the eject switch 133.

FIG. 2 is a flow chart of a control method for illustrating the process of stopping supplying the operating voltage to the optical disc drive 100 while no data transmission is being performed between the optical disc drive 100 and the corresponding computer system as depicted in FIG. 1. Firstly, the computer system (a note PC) is in operation (step 301) and the computer system keeps detecting whether or not a tray 113 of the optical disc drive 100 is loaded into the optical disc drive 100 (step 303). If the tray 113 is determined to be loaded into the optical disc drive 100 and there is no data transmission being performed between the computer system and the optical disc drive 100, the embedded controller 25 then turns off the switch transistor 153 and stops supplying the operating voltage to the optical disc drive 100 (step 305), accordingly there will be no any electric power consumed by the optical disc drive 100. In the optical disc drive 100, it is noted that the potential on the shared line is still maintained at the predetermined value meanwhile.

The embedded controller 25 then keeps detecting whether or not the eject switch 133 is being pressed (step 307). Specifically, an ejection signal B is produced and through the shared line is transmitted to the embedded controller 25 If the eject switch 133 is being pressed (step 309), thereby the embedded controller 25 can determine whether or not the eject switch 133 is being pressed according to the ejection signal B. Once receiving the ejection signal B, the embedded controller 25 controls the computer system to start to provide the operating voltage and power on the optical disc drive 100 (step 311).

When the optical disc drive 100 is supplied with the operating voltage again and after a predetermined time period (step 313), the embedded controller 25 outputs a pseudo ejection single C through the shared line to the controller 125 (step 315); therefore, the controller 125 then ejects the tray 113 from the optical disc drive 100 once the pseudo ejection single C is detected at the ejection detecting terminal thereof (step 317).

Based on the above description about the conventional optical disc drive, a user must firstly press the eject switch 133 to eject the tray 113 from the optical disc drive 100 so that the user can put the optical disc 111 on the ejected tray 113 if the user tries to read/write data through the optical disc drive 100. Although the logic-low ejection signal B is produced and outputted from the eject switch 113 to the controller 125 while the eject switch 113 is being pressed, the controller 125 is not powered and unable to detect the logic-low ejection signal B through its ejection detecting terminal.

In response to the logic-low ejection signal B received by the embedded controller on the shared line, the embedded controller 25 controls the switch transistor 153 to be operated at a close state so that the operating voltage is able to be supplied to the optical disc drive 100 via the close-state switch transistor 153. After a predetermined time period so that the optical disc drive 100 is at a normal function state and can work properly, the embedded controller 25 then produces the pseudo ejection single C through the shared line to the ejection detecting terminal of the controller 125, and the controller 125 controls the ejection mechanism 119 to eject the tray 113 from the optical disc drive 100 in response to the pseudo ejection single C. Therefore, the tray 113 is successfully ejected from the optical disc drive 100 and the user can put the optical disc 111 on the ejected tray 113 for data transmission.

However, before stopping supplying the operating voltage to the optical disc drive, the computer system must firstly make sure that the tray is at a loaded-in state as depicted in FIG. 2. In other words, even there is no data transmission being performed between the computer system and the optical disc drive, the computer system still supplies the operating voltage to the optical disc drive if the tray of the optical disc drive is not at a loaded-in state but at an ejected state, thereby electric power is still consuming.

Moreover, if the computer system stops supplying the operating voltage to the optical disc drive while the tray of the optical disc drive is at an ejected state, there is no efficient mechanism for the optical disc drive to request the computer system to re-supply the operating voltage due to the optical disc drive is not supplied with the operating voltage. In other words, once the computer system stops supplying the operating voltage to the optical disc drive with an ejected tray, the optical disc drive still cannot work properly even the user put the optical disc on the tray and load the tray into the optical disc drive.

### SUMMARY OF THE INVENTION

Therefore, the present invention relates to an optical disc drive and a control method thereof. In the optical disc drive and the control method, the operating voltage is stopped supplying to the optical disc drive if no data transmission is being performed between the optical disc drive and the computer system, no matter the tray is loaded into the optical disc drive or not. Moreover, even not supplied with the operation voltage, the optical disc drive can be back to a normal function state when the tray is pushed into or the eject switch is pressed.

An embodiment of the present invention provides a control method for an optical disc drive and a computer system, which includes following steps: detecting whether or not data transmission is being performed between the computer system and the optical disc drive when the computer system is in operation; stopping supplying an operating voltage to the optical disc drive if there is no data transmission being performed between the computer system and the optical disc drive, and supplying a first voltage on a shared line, which is electrically coupled between the computer system and the optical disc drive, from the computer system to the optical disc drive; determining whether or not an eject switch is being pressed according to a variation in potential on the shared line when a first logic level is detected on the potential on the sharing signal line, and supplying the operating voltage to the optical disc drive if a press on the eject switch is detected and then after a predetermined time ejecting a tray from the optical disc drive; and determining whether or not the tray is loaded into the optical disc drive according to a variation in potential on the shared line when a second logic level is detected on the potential on the sharing signal line, and supplying the operating voltage to the optical disc drive if the tray is determined to be loaded into the optical disc drive.

Another embodiment of the present invention provides an optical disc drive electrically coupled to a computer system, which includes: an operating unit having an ejection pin, a tray pin, and an internal-power-source-receiving terminal for receiving an internal voltage; a tray capable of being ejected from the optical disc drive through a control of the operating unit; a tray detecting switch electrically coupled to the tray pin and detecting the tray's position; an eject switch electrically coupled to the ejection pin and detecting a pressing state thereof; a power supply circuit for receiving an operating voltage from the computer system and converting the operating voltage into the internal voltage; and a shared line electrically coupled to the ejection pin, the tray pin, and the computer system, wherein a first voltage is supplied on the shared line when the operating voltage is not supplied from the computer system to the optical disc drive.

Another embodiment of the present invention provides an optical disc drive electrically coupled to a computer system, which includes: an operating unit having an internal-power-source-receiving terminal for receiving an internal voltage; a power supply circuit for receiving an operating voltage from the computer system and converting the operating voltage into the internal voltage; a shared line electrically coupled to the computer system, wherein a first voltage is supplied on the shared line when the operating voltage is not supplied from the computer system to the optical disc drive; and a switch circuit electrically coupled to the operating unit and the shared line, wherein the switch circuit is configured to an open state when the operating voltage is supplied from the computer system to the optical disc drive; and the switch circuit is configured to a close state when the operating voltage is not supplied from the computer system to the optical disc drive.

Another embodiment of the present invention provides a control method for an optical disc drive and a computer system, which includes following steps: stopping supplying an operating voltage to the optical disc drive if there is no data transmission being performed between the computer system and the optical disc drive; determining a state of a tray according to a potential level on a shared line, which is electrically coupled between the computer system and the optical disc drive; determining whether or not an eject switch is being pressed according to a variation in potential on the shared line when the tray is determined at a load-in state, and supplying the operating voltage to the optical disc drive if a press on the eject switch is detected; and determining whether or not the tray is loaded into the optical disc drive according to a variation in potential on the shared line when the tray is determined at an ejected state, and supplying the operating voltage to the optical disc drive if the tray is determined to be loaded into the optical disc drive.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (Prior art) is a schematic block diagram illustrating a conventional optical disc drive adapted to be used with a computer system;

FIG. 2 (Prior art) is a flow chart of a control method for illustrating the process of stopping supplying an operating voltage to the optical disc drive while no data transmission is being performed between the optical disc drive and the corresponding computer system as depicted in FIG. 1;

FIG. 3 is a schematic diagram illustrating an optical disc drive adapted to be used with a computer system in accordance with a first embodiment of the present invention;

FIG. 4A is a timing diagram of related signals in the optical disc drive adapted to be used with a computer system in accordance with the first embodiment of the present invention under a specific initial condition of without being supplied with the operating voltage Vop and with a loaded-in-state tray;

FIG. 4B is a timing diagram of related signals in the optical disc drive adapted to be used with a computer system in accordance with the first embodiment of the present invention under a specific initial condition of without being supplied with the operating voltage Vop and with an ejected-state tray;

FIG. 5 is a schematic diagram illustrating an optical disc drive adapted to be used with a computer system in accordance with a second embodiment of the present invention;

FIG. 6A is a timing diagram of related signals in the optical disc drive adapted to be used with a computer system in accordance with the second embodiment of the present invention under a specific initial condition of without being supplied with the operating voltage Vop and with a loaded-in-state tray;

FIG. 6B is a timing diagram of related signals in the optical disc drive adapted to be used with a computer system in accordance with the second embodiment of the present invention under a specific initial condition of without being supplied with the operating voltage Vop and with an ejected-state tray; and

FIG. 7 is a flow chart of a controlling method adopted to an optical disc drive which is adapted to be used with a computer system according to the present invention.

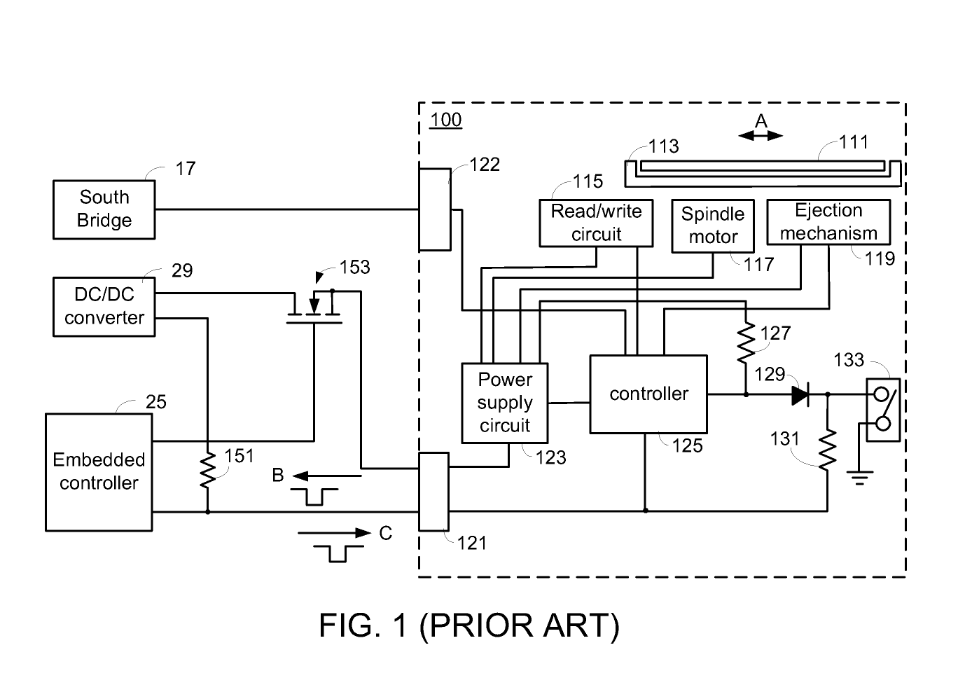

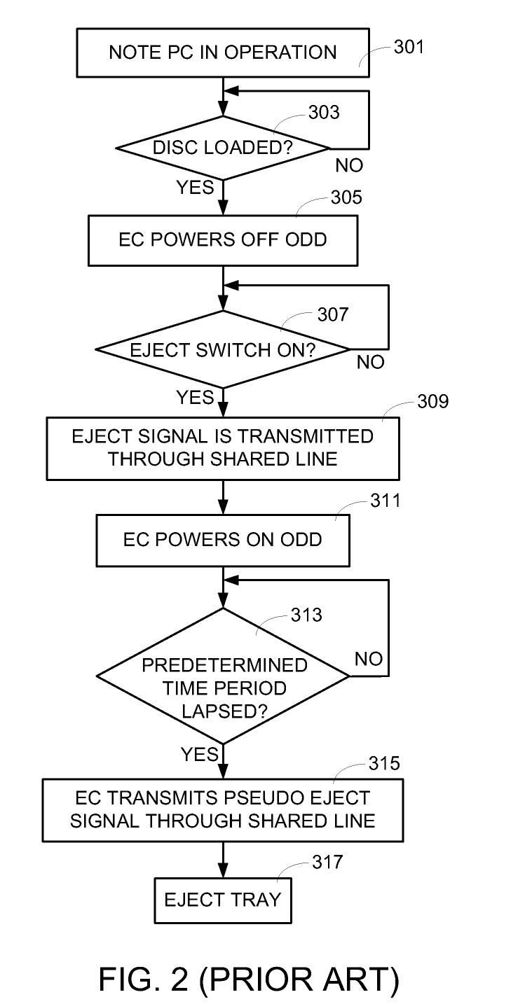

### DETAILED DESCRIPTION OF PREFERRED EMBODIMENTS

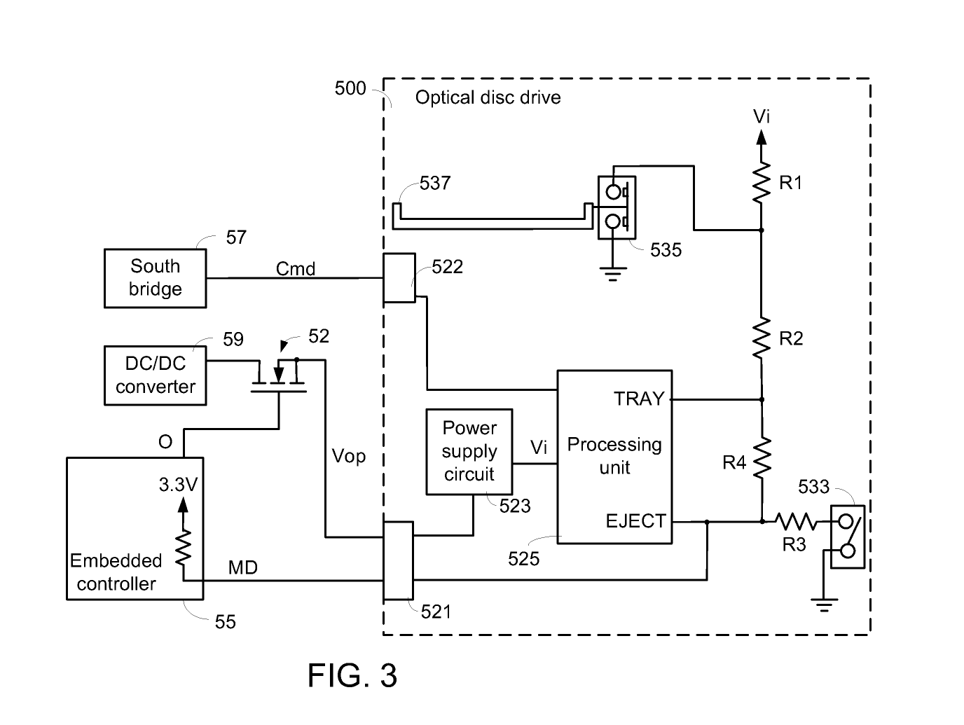

FIG. 3 is a schematic diagram illustrating an optical disc drive adapted to be used with a computer system in accordance with a first embodiment of the present invention. The computer system comprises a south bridge 57, a DC/DC converter 59, an embedded controller 55, and a switch transistor 52. The optical disc drive 500 comprises a signal terminal 522, a power supply terminal 521, a power supply circuit 523, an processing unit 525, a tray detecting switch 535, an eject switch 533 and a tray 537. It is noted that the optical disc drive 500 may further comprise other mechanical structures or electronic components, such as an ejection mechanism or a read/write circuit; however, these mechanical structures or electronic components not much involve to the present invention, thereby no any unnecessary detail about these not-shown mechanical structures or electronic components is given here. Moreover, in the embodiment, the computer system is capable of stopping supplying the operating voltage Vop to the optical disc drive 500 any time if there is no data transmission being performed between the computer system and the optical disc drive 500.

The south bridge 57 is electrically coupled to the signal terminal 522 and is configured to output a variation of control commands Cmd to the processing unit 525 for controlling the optical disc drive 500 to perform corresponding specific actions, such as reading/writing data from/to an optical disc (not shown). The DC/DC converter 59 is configured to supply an operating voltage Vop sequentially via the switch transistor 52 and the power supply terminal 521 to the power supply circuit 523. In the embodiment, the operating voltage Vop has a value of 5V.

Moreover, the embedded controller 55 is configured to output a transistor controlling signal O to the switch transistor 52 for controlling the switch transistor 52 to be operated either at an open state or a close state. A shared line MD is arranged between the embedded controller 55 and the optical disc drive 500 and specifically for electrically coupling the embedded controller 55 and the eject pin (EJECT) of the processing unit 525 through the power supply terminal 521. In the embodiment, the potential on the shared line MD is normally maintained at an internal voltage Vi (e.g., 3.3V) by a pull-up resistor which is arranged in the embedded controller 55, no matter whether or not the optical disc drive 500 is supplied with the operating voltage Vop.

Generally, the operating voltage Vop is converted into a predetermined value (3.3V) by the power supply circuit 523 after being supplied to the power supply circuit 523, and consequently the optical disc drive 500 is at a normal function state once the operating voltage Vop with the predetermined value (3.3V) is further supplied to the processing unit 525 and other related circuits not shown.

Moreover, the processing unit 525 has a tray pin (TRAY) for detecting the operating state of the tray 537 and an eject pin (EJECT) for detecting whether or not the eject switch 533 is being pressed.

In the first embodiment of the present invention, the tray 537 will contact to the tray detecting switch 535 thus resulting in the tray detecting switch 535 to be operated at an open state when the tray 537 is at a loaded-in state which indicating that the tray 537 is loaded into the optical disc drive 500. Oppositely, the tray 537 will not contact to the tray detecting switch 535 thus resulting in the tray detecting switch 535 to be operated at a close state when the tray 537 is at an ejected state which indicating that the tray 537 is ejected from the optical disc drive 500. Based on the same manner, the eject switch 533 is at a close state while the eject switch 533 is being pressed; and, the eject switch 533 is at an open state while the eject switch 533 is not being pressed.

Moreover, the tray detecting switch 535 has its first terminal electrically coupled to ground and its second terminal electrically coupled to an internal voltage Vi through a first resistor R1. The second terminal of the tray detecting switch 535 is also electrically coupled to the tray pin (TRAY) of the processing unit 525 through a second resistor R2. The eject switch 533 has its first terminal electrically coupled to ground and its second terminal through a third resistor R3 electrically coupled to the eject pin (EJECT) of the processing unit 525. The eject pin (EJECT) of the processing unit 525 is also electrically coupled to the shared line MD. The tray pin (TRAY) and the eject pin (EJECT) of the processing unit 525 are electrically coupled to each other through a fourth resistor R4. In the embodiment, the first resistor R1 is 1000 ohms, the second resistor R2 is 390 ohms, the third resistor R3 is 1200 ohms and the fourth resistor R4 is 390 ohms, but not intend to limit the present invention.

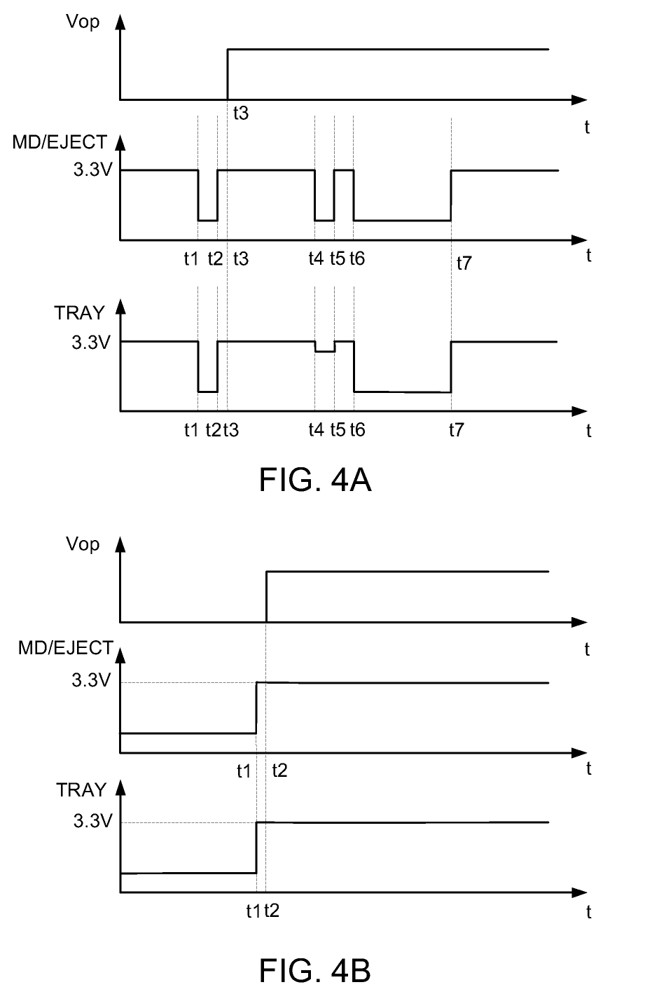

FIG. 4A is a timing diagram of related signals in the optical disc drive 500 adapted to be used with a computer system in accordance with the first embodiment of the present invention under a specific initial condition of without being supplied with the operating voltage Vop and with a loaded-in-state tray 537. As shown, the operating voltage Vop is not supplied to the optical disc drive 500 before time t3. Moreover, initially the potential on the shared line MD (or the eject pin (EJECT) of the processing unit 525) is maintained at the internal voltage Vi (3.3V) by the embedded controller 55 until the eject switch 533 is being pressed at time t1. In other words, the potential on the shared line MD (or the eject pin (EJECT) of the processing unit 525) will be maintained at the internal voltage Vi (3.3V) which indicating as a logic-high level if the tray 537 is at a loaded-in state when the optical disc drive 500 is not supplied with the operating voltage Vop.

Between times t1 to t2, the eject switch 533 is being pressed thereby is operated at a close state, so the potential on the shared line MD (or the eject pin (EJECT) of the processing unit 525) is converted into a relatively low voltage, compared to the internal voltage Vi (3.3V) and indicated as a logic-low level. At time t2, the potential on the shared line MD (or the eject pin (EJECT) of the processing unit 525) is converted into a logic-high level due to the eject switch 533 is not being pressed any more at time t2 and thus the eject switch 533 is switched to an open state. Based on the same manner, the potential at the tray pin (TRAY) of the processing unit 525 has a similar variation in voltage.

In addition, in response to a rising edge of the potential on the shared line MD at time t2, the transistor controlling signal O is outputted from the embedded controller 55 at time t3 for switching the switch transistor 52 to a close state, thereby the operating voltage Vop can be supplied to the optical disc drive 500 via the close-state switch transistor 52 at time t3.

The optical disc drive 500 is back to a normal function state at time t4, after a predetermined time (between time t3 to time t4) when supplied with the operating voltage Vop at time 3. Between time t4 and time t5, the embedded controller 55 provides a logic-low level signal to the eject pin (EJECT) of the processing unit 525, and the potential on the shared line MD (or, the eject pin (EJECT) of the processing unit 525) is converted into a logic-low level, so that tray 537 is ejected from the optical disc drive 500 at time t6 and users can put an optical disc (not shown) on the ejected tray 537 for data transmission. Because the tray 537 is ejected from the optical disc drive 500 and accordingly operated at a close state after time t6, the potential on the shared line MD is maintained at a logic-low level after time t6 until the tray 537 is loaded into the optical disc drive 500 next time.

Moreover, because the optical disc drive 500 is back to a normal function state at time t3, the embedded controller 55 can provide a logic-low level signal to the optical disc drive for controlling the ejection of the tray 537. It is noticed that the tray pin (TRAY) of the processing unit 525 may have a potential drop between time t4 and t5; however, the potential drop is too small to affect the determination of the logic level of the potential at the tray pin (TRAY) of the processing unit 525 between time t4 and t5.

At time t7, the tray 537 is pushed into to the optical disc drive 500 and operated at a loaded-in state, accordingly the tray detecting switch 535 is at an open state thereby the potential on the shared line MD (or the tray pin (TRAY) of the processing unit 525) is converted into a logic-high level, so that the optical disc drive 500 can start to read/write data from/to the optical disc.

FIG. 4B is a timing diagram illustrating related signals in the optical disc drive 500 adapted to be used with a computer according to the first embodiment under a specific initial condition of without being supplied with the operating voltage Vop and with an ejected-state tray 537. As shown, the operating voltage Vop is not supplied to the optical disc drive 500 before time t2. Because the tray 537 is initially operated at an ejected state which indicates the tray 537 is ejected from the optical disc drive 500, accordingly the tray detecting switch 535 is at a close state thereby the potential on the shared line MD (or, the tray pin (TRAY) of the processing unit 525) is pulled down to a logic-low level before time t1. In other words, the potential on the shared line MD will be maintained at a logic-low level if the tray 537 is at an ejected state when the optical disc drive 500 is not supplied with the operating voltage Vop.

At time t1, the tray 537 is pushed into the optical disc drive 500. Because the tray 537 is at a load-in state so as being contacted to the tray detecting switch 535, the tray detecting switch 535 is at an open state and the potential on the shared line MD (or, the tray pin (TRAY) of the processing unit 525) is pulled up to a logic-high level at time t1. In response to a rising edge of the potential on the shared line MD at time t1, the transistor controlling signal O is outputted from the embedded controller 55 at time t2 for switching the switch transistor 52 to a close state, so that the optical disc drive 500 is back to a normal function state while supplied with the operating voltage Vop at time t2.

Therefore, in the first embodiment, the embedded controller 55 firstly determines the tray 537 is at a load-in state or an ejected state based on the potential on the shared line MD when the optical disc drive 500 is not supplied with the operating voltage Vop. The embedded controller 55 then determines whether or not to convert the potential on the shared line MD into a logic-low level based on the operating state of the tray 537 when a rising edge of the potential on the shared line MD is detected.

In other words, when the optical disc drive 500 is not supplied with the operating voltage Vop, the tray 537 of the optical disc drive 500 is determined at a loaded-in state if the potential on the shared line MD is at a logic-high level, the embedded controller 55 then converts the potential on the shared line MD into a logic-low level for ejecting the tray 537 from the optical disc drive 500 if a rising edge of the potential on the shared line MD is detected. Alternatively, the tray 537 of the optical disc drive 500 is determined at an ejected state if the potential on the shared line MD is at a logic-low level, the embedded controller 55 then will not convert the logic-low-level potential on the shared line MD if a rising edge of the potential on the shared line MD is detected for there is no need to eject the tray 537 in this case.

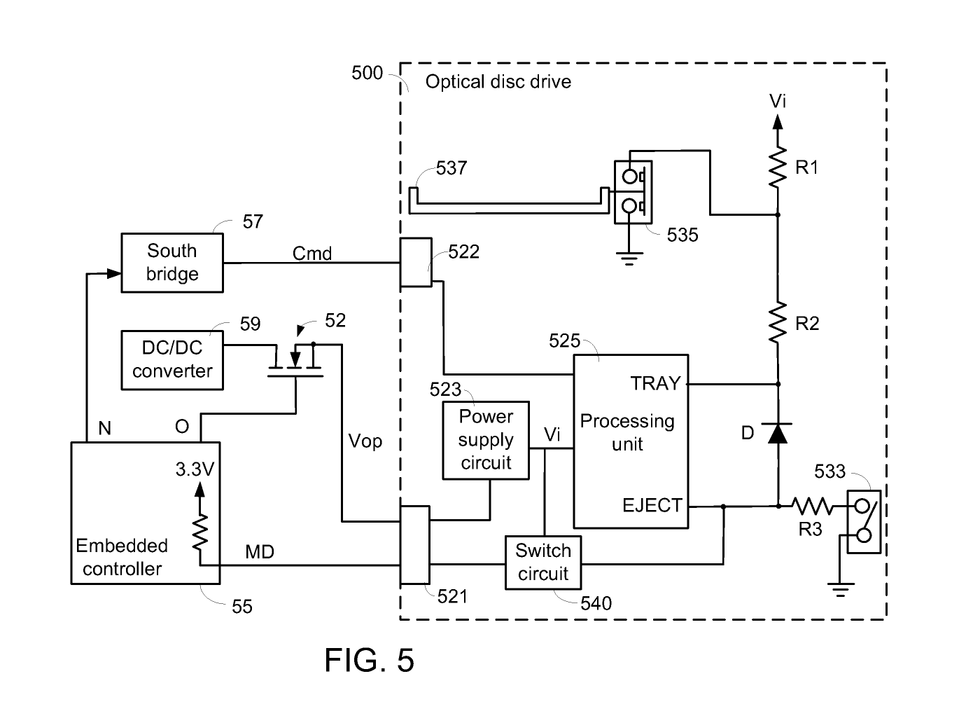

FIG. 5 is a schematic diagram illustrating an optical disc drive adapted to be used with a computer system in accordance with a second embodiment of the present invention. Compared to the first embodiment depicted in FIG. 3, the optical disc drive 500 in the second embodiment adopts a diode D instead of the fourth resistor R4, and further comprises a switch circuit 540. It is noted that the optical disc drive 500 in the second embodiment can only adopt the diode D instead of the fourth resistor R4 without the switch circuit 540, or only comprise the switch circuit 540 without the diode D.

As depicted in FIG. 5, the diode D has its anode and cathode terminals electrically coupled to the eject pin (EJECT) and the tray pin (TRAY) of the processing unit 525, respectively. The switch circuit 540 has its controlling terminal for controlling the switch circuit 540 to be operated either at an open state or a close state according to the internal voltage Vi; specifically, the switch circuit 540 is at an open state if the interval voltage Vi is supplied to the controlling terminal, and the switch circuit 540 is at a close state if the interval voltage Vi is not supplied to the controlling terminal.

In the second embodiment, the diode D is for preventing the potential at the tray pin (TRAY) of the processing unit 525 to be converted into a logic-low level while the optical disc drive 500 is at a normal function state and the eject switch 533 is being pressed, consequently the processing unit 525 can avoid to mistakenly determine the operating state of the tray 537.

In the second embodiment, the switch circuit 540 and the processing unit 525 are electrically coupled to the shared line MD. If the optical disc drive 500 is not supplied with the operating voltage Vop so the internal voltage Vi is not supplied to the controlling terminal of the switch circuit 540, the switch circuit 540 is operated at a close state and accordingly a closed state is established between the shared line MD and the processing unit 525, and the operating states of the eject switch 533 and the tray detecting switch 535 can be detected based on the potential on the shared line MD. Alternatively, if the optical disc drive 500 is supplied with the operating voltage Vop so the internal voltage Vi is supplied to the controlling terminal of the switch circuit 540, the switch circuit 540 is operated at an open state and accordingly an open state is established between the shared line MD and the processing unit 525. Via this configuration, a false logic-low signal will not be able to transmit to the optical disc drive 500 via the shared line MD, and thus mistakenly ejecting the tray 537 from the optical disc drive 500 is avoided.

As mentioned above, when the optical disc drive 500 is supplied with the operating voltage Vop and thus an open state is established between the shared line MD and the processing unit 525, ejecting the tray 537 from the optical disc drive 500 cannot be done through the embedded controller 55 by converting the potential on the shared line MD into a logic-low level. In the embodiment, an indicating signal N is outputted from the embedded control 55 to the south bridge 57, and accordingly an ejection command, for ejecting the tray 537 form the optical disc drive 500, is outputted from the south bridge 57 to the processing unit 525.

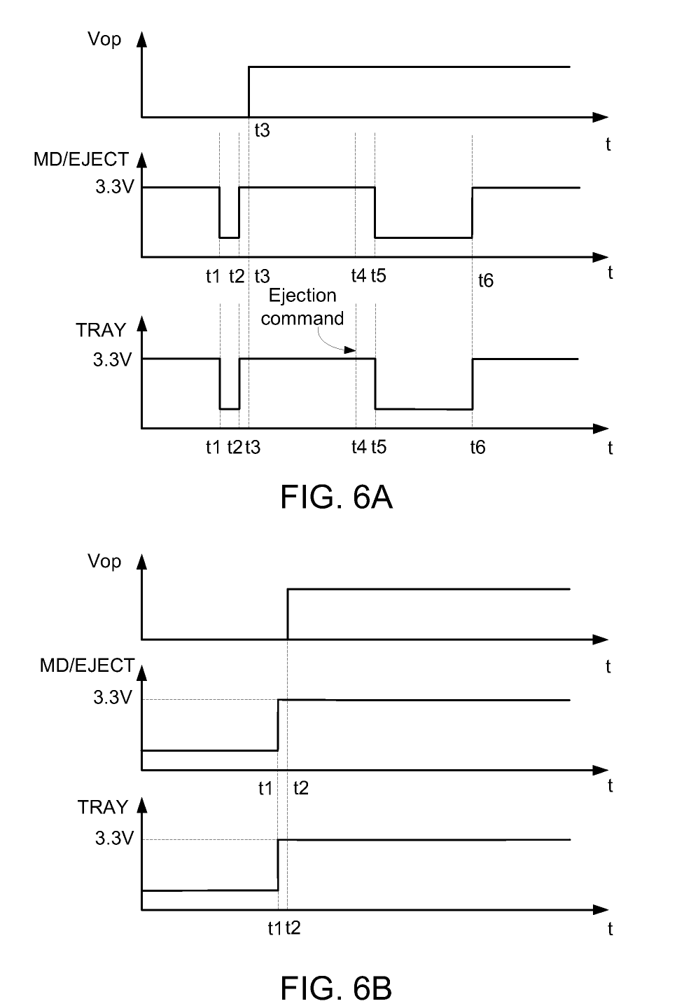

FIG. 6A is a timing diagram of related signals in the optical disc drive 500 adapted to be used with a computer system in accordance with the second embodiment of the present invention under an initial condition of without being supplied with the operating voltage Vop and with a loaded-in-state tray 537. As shown, the operating voltage Vop is not supplied to the optical disc drive 500 before time t3. Moreover, the potential on the shared line MD (or the eject pin (EJECT) of the processing unit 525) is initially maintained at the internal voltage Vi (3.3V) by the embedded controller 55 until the eject switch 533 is being pressed at time t1. In other words, when the optical disc drive 500 is not supplied with the operating voltage Vop, the potential on the shared line MD (or the eject pin (EJECT) of the processing unit 525) will be maintained at the internal voltage Vi (3.3V) which indicating as a logic-high level if the tray 537 is at a loaded-in state.

Between time t1 to t2, the eject switch 533 is being pressed thereby is operated at a close state, so the potential on the shared line MD (or the eject pin (EJECT) of the processing unit 525) is converted into a relatively low voltage, compared to the internal voltage Vi (3.3V) and indicated as a logic-low level. At time t2, the potential on the shared line MD (or the eject pin (EJECT) of the processing unit 525) is converted into a logic-high level due to the eject switch 533 is not being pressed any more at time t2 and thus the eject switch 533 is switched to an open state. Based on the same manner, the potential at the tray pin (TRAY) of the processing unit 525 has a similar variation in voltage.

In addition, in response to a rising edge of the potential on the shared line MD at time t2, the transistor controlling signal O is outputted from the embedded controller 55 at time t3 for switching the switch transistor 52 to a close state, thereby the operating voltage Vop can be supplied to the optical disc drive 500 via the close-state switch transistor 52 at time t3.

Once supplied with the operating voltage Vop, the optical disc drive 500 is back to a normal function state after a predetermined time (between time t3 to time t4). Therefore, an indicating signal N is outputted from the embedded controller 55 to the south bridge 57 for controlling the south bridge 57 to output an ejection command to the processing unit 525 at time t4, accordingly the tray 537 is ejected from the optical disc drive 500 at time t5 so users can put an optical disc (not shown) on the ejected tray 537 for data transmission.

At time t6, the tray 537 is pushed into to the optical disc drive 500 and the tray detecting switch 535 is switched to an open state, thereby the potential on the shared line MD (or, the tray pin (TRAY) of the processing unit 525) is converted into a logic-high level, so that the optical disc drive 500 can start to read/write data from/to the optical disc.

FIG. 6B is a timing diagram of related signals in the optical disc drive 500 adapted to be used with a computer system in accordance with the second embodiment of the present invention under an initial condition of without being supplied with the operating voltage Vop and with an ejected-state tray 537. As shown, the operating voltage Vop is not supplied to the optical disc drive 500 before time t2. Because the tray 537 is ejected from the optical disc drive 500 initially, the tray detecting switch 535 is at a close state so the potential on the shared line MD (or, the tray pin (TRAY) of the processing unit 525) is pulled down to a logic-low level. In other words, when the operating voltage Vop is not supplied to the optical disc drive 500, the potential on the shared line MD (or the eject pin (EJECT) of the processing unit 525) will be at a logic-low level if the tray 537 is at an ejected state.

At time t1, the tray 537 is pushed into the optical disc drive 500, so the tray detecting switch 535 is converted into an open state and the potential on the shared line MD (or, the tray pin (TRAY) of the processing unit 525) is pulled up to a logic-high level at time t1. In response to a rising edge of the potential on the shared line MD at time t1, the transistor controlling signal O is outputted from the embedded controller 55 at time t2 for switching the switch transistor 52 to a close state, so that the optical disc drive 500 is supplied with the operating voltage Vop and the optical disc drive 500 is at a normal function state again at time t2.

Therefore, in the second embodiment, the embedded controller 55 firstly determines the tray 537 is at a load-in state or an ejected state based on the potential on the shared line MD when the optical disc drive 500 is not supplied with the operating voltage Vop. The embedded controller 55 then determines whether or not to control the south bridge 57 to output the ejection command, for ejecting the tray 537 from the optical disc drive 500, based on the operating state of the tray 537 while a rising edge of the potential on the shared line MD Is detected.

In other words, while the optical disc drive 500 is not supplied with the operating voltage Vop, the tray 537 is determined loaded into the optical disc drive 500 (load-in state) if the potential on the shared line MD is at a logic high level, so that an ejection command for ejecting the tray 537 from the south bridge 57 is produced when the embedded controller 55 detects a rising edge of the potential on the shared line MD and then outputs an indicating signal N to the south bridge 57. Or, the tray 537 is determined ejected from the optical disc drive 500 (ejected state) if the potential on the shared line MD is at a logic low level, so that the ejection command will not be produced when the embedded controller 55 detects a rising edge of the potential on the shared line MD.

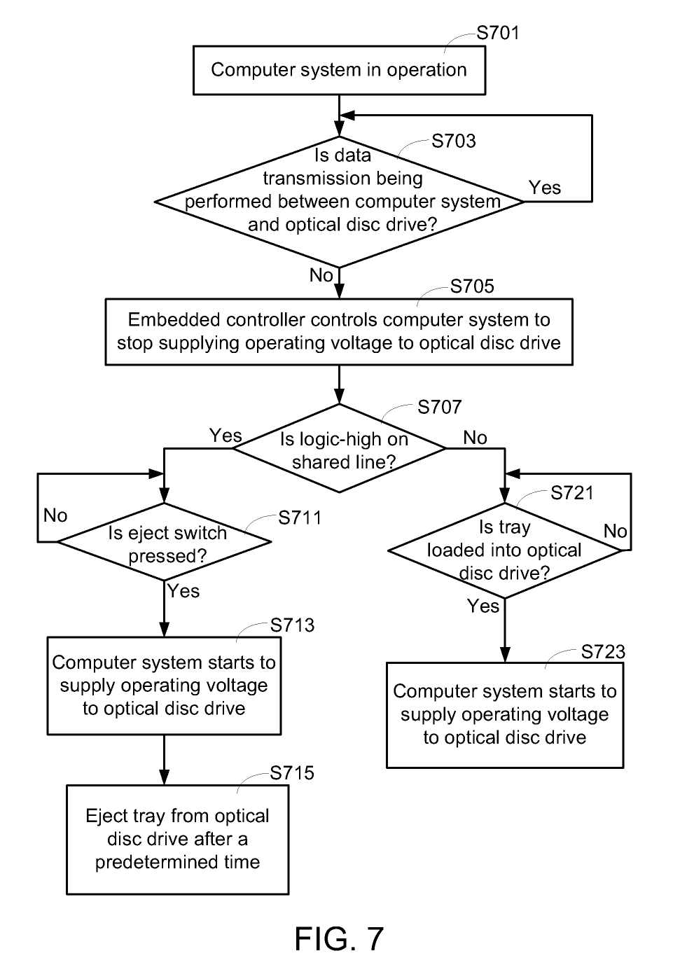

FIG. 7 is a flow chart of a controlling method adopted to an optical disc drive which is adapted to be used with a computer system according to the present invention. Firstly, the computer is in operation (step S701). A data transmission is detected whether or not being performed between the computer system and the optical disc drive (step S703). An embedded controller controls the computer system to stop supplying the operating voltage to the optical disc drive if there is no data transmission being performed between the computer system and the optical disc drive (step S705).

A logic level on a shared line is detected after the optical disc drive is not supplied with the operating voltage (step S707). Specifically, the tray of the optical disc drive is determined to be at an ejected state if the potential on the shared line is at a logic-low level. The embedded controller determines whether or not the tray is pushed into the optical disc drive based on the variation in potential on the shared line (step S721). The computer system starts to supply the operating voltage to the optical disc drive if the tray is loaded into the optical disc drive (step S723).

Or, the tray is determined to be at a load-in state if the potential on the shared line is at a logic-high level at step S707. The embedded controller determines whether or not the eject switch is being pressed based on the variation in potential on the shared line (step S711). The computer system start to supply the operating voltage to the optical disc drive if a press on the eject switch is detected (step S713). The tray is ejected from the optical disc drive after a predetermined time (step S715).

In the step S715, the step of ejecting the tray 537 from the optical disc drive 500 is realized through the embedded controller 55 converting the potential on the shared line MD to a logic low level in the first embodiment; or realized through the embedded controller 55 outputting an indicating signal to the south bridge 57 and accordingly the south bridge 57 outputting an ejection command to the optical disc drive 500 via the signal terminal 522 in the second embodiment.

Therefore, in the optical disc drive and the control method between an optical disc drive and a computer system disclosed in the present invention, the operating voltage is stopped supplying to the optical disc drive from the computer system if data transmission is not being performed between the optical disc drive and the computer system no matter the tray of the optical disc drive is loaded into or ejected from the optical disc drive, so the power saving efficiency is improved consequently. Moreover, the operating voltage is supplied to the optical disc drive again thereby the optical disc drive can back to a normal function state when the tray is pushed into the optical disc drive or the eject switch is pressed while the optical disc drive is not supplied with the operating voltage.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for an optical disc drive which is adapted to be used with a computer system, comprising steps of:
detecting whether or not data transmission is being performed between the computer system and the optical disc drive when the computer system is in operation;
stopping supplying an operating voltage to the optical disc drive if there is no data transmission being performed between the computer system and the optical disc drive, and supplying a first voltage on a shared line, which is electrically coupled between the computer system and the optical disc drive, from the computer system to the optical disc drive;
determining whether or not an eject switch is being pressed according to a variation in potential on the shared line when a first logic level is detected on the potential on the sharing signal line, and supplying the operating voltage to the optical disc drive if a press on the eject switch is detected and then after a predetermined time ejecting a tray from the optical disc drive; and
determining whether or not the tray is loaded into the optical disc drive according to a variation in potential on the shared line when a second logic level is detected on the potential on the sharing signal line, and supplying the operating voltage to the optical disc drive if the tray is determined to be loaded into the optical disc drive.

2. The control method as claimed in claim 1, wherein the determinations of whether or not the eject switch is being pressed or the tray is loaded into the optical disc drive are realized according to a rising edge or a falling edge of the potential on the shared line.

3. The control method as claimed in claim 1, wherein the first logic level is a logic high level and the second logic level is a logic low level.

4. The control method as claimed in claim 1 further comprising a step of: supplying a variation of potential level on the shared line, for ejecting the tray from the optical disc drive, after the eject switch is pressed and the operating voltage is supplied to the optical disc drive.

5. The control method as claimed in claim 1 further comprising a step of: outputting an ejection command from the computer system to the optical disc drive for ejecting the tray from the optical disc drive after the eject switch is pressed and the operating voltage is supplied to the optical disc drive.

6. The control method as claimed in claim 1 further comprising a step of: establishing an open state between the shared line and the optical disc drive after the operating voltage is supplied to the optical disc drive.

7. An optical disc drive electrically coupled to a computer system, comprising:
an operating unit having an ejection pin, a tray pin, and an internal-power-source-receiving terminal for receiving an internal voltage;
a tray capable of being ejected from the optical disc drive through a control of the operating unit;
a tray detecting switch electrically coupled to the tray pin and detecting the tray's position;
an eject switch electrically coupled to the ejection pin and detecting a pressing state thereof;
a power supply circuit for receiving an operating voltage from the computer system and converting the operating voltage into the internal voltage; and
a shared line electrically coupled to the ejection pin, the tray pin, and the computer system, wherein a first voltage is supplied on the shared line when the operating voltage is not supplied from the computer system to the optical disc drive.

8. The optical disc drive as claimed in claim 7, wherein when the optical disc drive is not supplied with the operating voltage, the tray is determined to be at load-in state if potential on the shared line is at a first logic level; and the tray is determined to be at ejected state if potential on the shared line is at a second logic level.

9. The optical disc drive as claimed in claim 8, wherein the first logic level is a logic high level and the second logic level is a logic low level.

10. The optical disc drive as claimed in claim 7, wherein when the optical disc drive is not supplied with the operating voltage and the tray is at load-in state, whether or not the eject switch is being pressed is determined based on a variation in potential on the shared line; and the operating voltage is supplied to the optical disc drive from the computer system and after a determined time the tray is ejected from the optical disc drive by the computer system if the eject switch is pressed.

11. The optical disc drive as claimed in claim 10, wherein a variation of potential level is supplied on the shared line for ejecting the tray from the optical disc drive after the eject switch is pressed and the operating voltage is supplied to the optical disc drive from the computer system.

12. The optical disc drive as claimed in claim 10, wherein an ejection command, for ejecting the tray from the optical disc drive, is produced and outputted from the computer system to the operating unit after the operating voltage is supplied to the optical disc drive from the computer system.

13. The optical disc drive as claimed in claim 10 further comprising a switch circuit, wherein an open state, between the shared line and the operating unit, is established by the switch circuit after the operating voltage is supplied to the optical disc drive from the computer system.

14. The optical disc drive as claimed in claim 8, wherein when the optical disc drive is not supplied with the operating voltage and the tray is at ejected state, the computer system determines whether or not the tray is loaded into the optical disc drive based on a variation in potential on the shared line; and the operating voltage is then supplied to the optical disc drive from the computer system if the tray is detected to be loaded into the optical disc drive.

15. The optical disc drive as claimed in claim 14 further comprising a switch circuit, wherein an open state, between the shared line and the operating unit, is established by the switch circuit after the operating voltage is supplied to the optical disc drive from the computer system.

16. The optical disc drive as claimed in claim 7 further comprising: a first resistor, a second resistor, a third resistor, and a fourth resistor, wherein a first terminal of the tray detecting switch is electrically coupled to ground, a second terminal of the tray detecting switch through the first resistor is electrically coupled to the internal voltage, the second terminal of the tray detecting switch through the second resistor is electrically coupled to the tray pin, a first terminal of the eject switch is electrically coupled to ground, a second terminal of the eject switch through the third resistor is electrically coupled to the ejection pin, the shared line is directly electrically coupled to the ejection pin, and the tray pin is electrically coupled to the ejection pin through the fourth resistor.

17. The optical disc drive as claimed in claim 7 further comprises: a first resistor, a second resistor, a third resistor, and a diode, wherein a first terminal of the tray detecting switch is electrically coupled to ground, a second terminal of the tray detecting switch through the first resistor is electrically coupled to the internal voltage, the second terminal of the tray detecting switch through the second resistor is electrically coupled to the tray pin, a first terminal of the eject switch is electrically coupled to ground, a second terminal of the eject switch through the third resistor is electrically coupled to the ejection pin, the shared line is directly electrically coupled to the ejection pin, and the tray pin is electrically coupled to a cathode terminal of the diode, and the ejection pin is electrically coupled to an anode terminal of the diode.

18. An optical disc drive electrically coupled to a computer system, comprising:
an operating unit having an internal-power-source-receiving terminal for receiving an internal voltage;
a power supply circuit for receiving an operating voltage from the computer system and converting the operating voltage into the internal voltage;
a shared line electrically coupled to the computer system, wherein a first voltage is supplied on the shared line when the operating voltage is not supplied from the computer system to the optical disc drive; and
a switch circuit electrically coupled to the operating unit and the shared line, wherein the switch circuit is configured to an open state when the operating voltage is supplied from the computer system to the optical disc drive; and the switch circuit is configured to a close state when the operating voltage is not supplied from the computer system to the optical disc drive.

19. The optical disc drive as claimed in claim 18, wherein potential on the shared line is at a first logic level when the optical disc drive is not supplied with the operating voltage and the tray is at load-in state; and, potential on the shared line is a second logic level when the optical disc drive is not supplied with the operating voltage and the tray is at ejected state.

20. The optical disc drive as claimed in claim 18 further comprising a signal terminal, wherein through the signal terminal an ejection command, for ejecting the tray from the optical disc drive, is outputted to the operating unit from the computer system when the optical disc drive is not supplied with the operating voltage.

21. A control method for an optical disc drive which is adapted to be used with a computer system, comprising steps of:
stopping supplying an operating voltage to the optical disc drive if there is no data transmission being performed between the computer system and the optical disc drive;
determining a state of a tray according to a potential level on a shared line, which is electrically coupled between the computer system and the optical disc drive;
determining whether or not an eject switch is being pressed according to a variation in potential on the shared line when the tray is determined at a load-in state, and supplying the operating voltage to the optical disc drive if a press on the eject switch is detected; and
determining whether or not the tray is loaded into the optical disc drive according to a variation in potential on the shared line when the tray is determined at an ejected state, and supplying the operating voltage to the optical disc drive if the tray is determined to be loaded into the optical disc drive.

22. The control method as claimed in claim 21, wherein the determinations of whether or not the eject switch is being pressed or the tray is loaded into the optical disc drive are realized according to a rising edge or a falling edge of the potential on the shared line.

23. The control method as claimed in claim 21 further comprising a step of: supplying a variation of potential level on the shared line, for ejecting the tray from the optical disc drive, after the press on the eject switch is detected and the operating voltage is supplied to the optical disc drive.

24. The control method as claimed in claim 21 further comprising a step of: outputting an ejection command from the computer system to the optical disc drive through a signal terminal for ejecting the tray from the optical disc drive after the press on the eject switch is detected and the operating voltage is supplied to the optical disc drive.

25. The control method as claimed in claim 21 further comprising a step of: establishing an open state between the shared line and the optical disc drive after the operating voltage is supplied to the optical disc drive.
